(19) United States
(12) Patent Application Publication
(10) Pub. No.: US 2005/0179705 A1
(43) Pub. Date: Aug. 18, 2005

(54) Navigation within a large computer file

(76) Inventors: Randy Ubillos, Los Antos, CA (US); Michael Mages, Oakland, CA (US); Laurent Perrodin, Menlo Park, CA (US); Daniel Waylonis, Mountain View, CA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/777,962

(22) Filed: Feb. 12, 2004

(51) Int. Cl. G09G 5/00; G06T 11/00

(52) U.S. Cl. 345/671; 345/660; 345/472

(57) ABSTRACT

Disclosed herein is a method and graphical user interface (GUI) for navigating within the contents of a computer file, and specifically within a large non-paginated graphical file. A first portion of the file is displayed at a first magnification. Thereafter, an option is selected to display a second portion of the contents of the file (preferably the entire file) at a second lower magnification. An area is defined within the displayed second portion that highlights the first portion. This area is moveable, preferably by clicking and dragging the area using a mouse pointer, to a new (third location) on the file. Thereafter, the method allows the third portion to be automatically or manually magnified as was the first portion.

### FIELD OF THE INVENTION

The present invention relates generally to a graphical user interface (GUI) for a computer, and more specifically to a GUI useful for viewing and navigating through large graphical files.

### BACKGROUND

In certain computing applications, a computer user might need to view a computer file that is so large that it cannot reasonably be viewed in its entirety on the user's computer display. A good example of such a file is a Computer Aided Design (CAD) file 10, which is illustrated in FIG. 1. The CAD file 10 in this example illustrates various views of a unit 12. Although the unit 12 as illustrated is relatively simple, one will recognize that for an extremely complicated unit, perhaps having many parts and subparts, the graphical workspace that shows all relevant portions of the unit 12 (and perhaps its manufacturing specifications, material specifications, and other things that might appear on a manufacturing drawing) can be quite large. As a result, the physical dimensions 14, 16 of the file 10 can be quite large, perhaps measuring in the tens of square feet or even larger.

Such physically large files 10 present a problem for the user. When the entire file is shown on the user's computer display 20, which usually measures no more the two feet at its diagonal, the details of the file (such as the various views of the unit 12) may be too small to see. Accordingly, the user must increase the magnification of the file to see only a relevant portion of interest, as shown in FIG. 2, in which the user has magnified the file to show only a particular portion of the file, namely view 12a of the unit (20a). The desired magnification of the file may be set by the user. For example, a “zoom” or magnification window 24 may be present in the application the user is using (or the operating system) to view the file 10 (e.g., a Visio™ or CAD file), which is usually associated with a menu bar 22 that provides the user other file manipulation capabilities (such as print, save, etc.). The magnification window 24 may allow the user to type in a desired magnification (using his mouse 25/mouse pointer 18 to first click on the window 24); may provide a drop down menu presenting preset magnification levels; or may present up/down magnification buttons, or similar schemes. Either way, assume that view 12a is shown at a 500% magnification on display 20a, which is close enough to allow the user to see all salient details of that view.

Of course, at some point, the user is going to wish to see other high magnification views of other portions of the file 10. For example, suppose the user wishes to later view 12b at high magnification (20c). The user traditionally uses one of two approaches to do this. In a first approach, the user could, preferably using his mouse 25/mouse pointer 18, engage scroll bars 26 associated with the magnified view to horizontally and vertically navigate around the file 10 at high magnification (e.g., 500%) in an iterative attempt to eventually find and center view 12b on his display. Similarly, the user may use the mouse pointer 18 (e.g., perhaps using his mouse's buttons 27, or by clicking and holding) to engage a mode to allow the user to drag the mouse pointer across the screen to navigate through file 10 in the direction of view 12b, again until that view is found and centered. However, because the user remains in a high magnification view, it is difficult to navigate to the desired new view 12b (20c) because its location is only generally known. Thus, locating such a view can be frustrating, and if the file 10 is large enough, the user can simply loose his bearings and eventually may have no idea where to find view 12b.

In a second approach, the user desiring to move to view 12b (20c) from view 12a (20a) can first gain his bearings by reducing the magnification to see a larger (or complete) portion of file 10 (20b). Thus, the user can engage the magnification window 24 to type or select a magnification level suitable for viewing enough of the file 10 to locate view 12b of interest (even if view 12b is only vaguely identifiable and can't be seen in suitable detail). The user may select a reduced magnification level (e.g., 100%) to achieve this goal, as shown in display 20b. Then, perhaps after navigating around at the lower magnification view, the user somehow centers the file 10 around view 12b, either by moving the low magnification image on the display 20, or by clicking view 12b with mouse pointer 18 to center it. Thereafter, the user can once again increase the magnification using magnification window 24 (e.g., to 500%) to see view 12b at a suitable magnification (20c). This high-low-high magnification navigation approach is preferable to the first approach in that the low magnification step allows the user to see a larger landscape of the file, which reduces the possibility of the user becoming “lost” in the file 10. However, it is still a cumbersome process requiring a lot of input and button pressing from the user.

Accordingly, an improved user interface and method for navigating within large graphical files is desired, and is provided by this disclosure.

### SUMMARY OF THE DISCLOSURE

Disclosed herein is a method and graphical user interface (GUI) for navigating within the contents of a computer file, and specifically within a large graphical file. A first portion of the file is displayed at a first magnification. Thereafter, an option is selected to display a second portion of the contents of the file (preferably the entire file) at a second lower magnification. An area is defined within the displayed second portion that highlights the first portion. This area is moveable, preferably by clicking and dragging the area using a mouse, to a new (third location) on the file. Thereafter, the method allows the third portion to be automatically or manually magnified.

### BRIEF DESCRIPTION OF THE DRAWINGS

FIG. 1 illustrates a prior art large graphical file showing several different views of a unit.

FIG. 2 illustrates several screen shots showing navigation from one portion of the file of FIG. 1 to another according to the prior art.

FIG. 3 illustrates a flow chart of the steps involved in navigating with a large graphical file in accordance with embodiments of the invention.

FIGS. 4-7 illustrate sequential screen shots for navigating within the large graphical file in accordance with embodiments of the invention.

FIGS. 8-9 illustrate a modification of the invention wherein the highlighted area is adjustable in size.

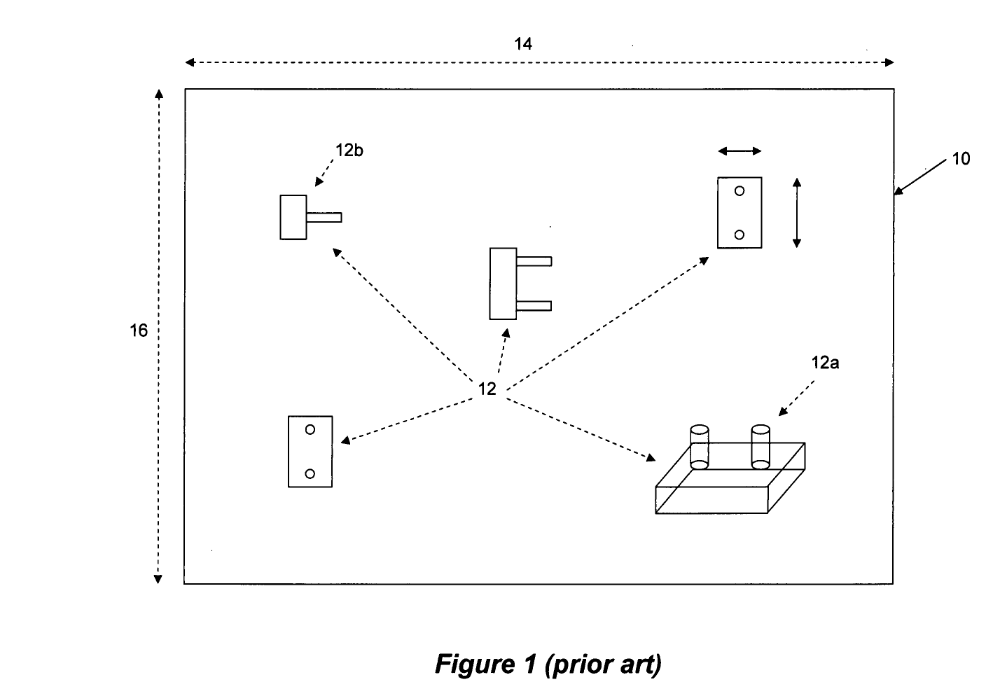

### DETAILED DESCRIPTION

In the interest of clarity, not every feature or implementation detail necessary to navigate within a large computer file in accordance with the invention is described in the disclosure that follows. It should be appreciated that in the development of an actual implementation of the invention, numerous engineering and design decisions must be made to achieve the developers' specific goals, which may vary. While attention must necessarily be paid to proper engineering and design practices, it should be appreciated that the development of and computer coding for a system for navigating within a large computer file would nevertheless be a routine undertaking for those of skill in the art given the details provided by this disclosure.

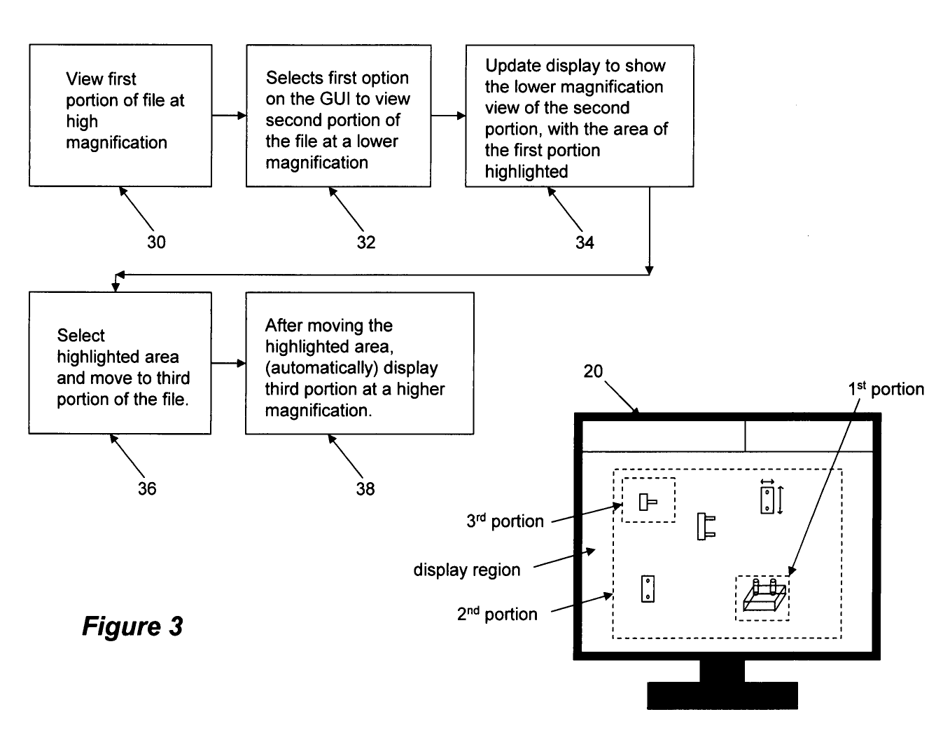

FIG. 3 shows one embodiment of an improved navigation scheme preferably useable with large files in a flow chart form. The flow chart describes embodiments of the invention at a general level, with further details to be shown in the GUI screen shots that follow.

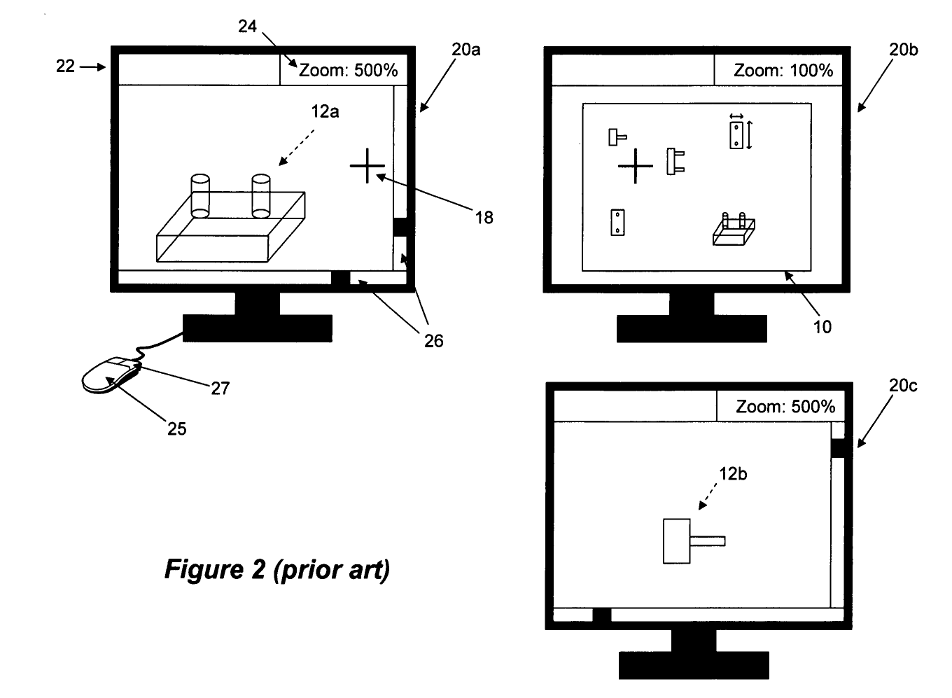

The process begins (30) assuming that some first portion of the file 10 is being viewed at high magnification (e.g., FIG. 2, 20a) on a region of the display. A user desiring to navigate to a different (third) portion of the file selects a first option on the GUI to view some second portion of the file (and preferably the whole file) at a lower magnification (32) on the region of the display. Thereafter, the user's display is updated to show the lower magnification view of the second portion, with the area of the first high magnification view (first portion) highlighted or bounded in some fashion so that user can understand the portion of the file he had previously been reviewing at high magnification (34). Thereafter, the user selects that highlighted area and moves it to encompass a third portion of the file—i.e., that portion that he wishes to view at high magnification (36), and preferably at the same magnification as the first portion. Thereafter, when moving of the highlighted area is finished, the third portion is displayed (preferably automatically) at the high magnification (38) on the region of the display.

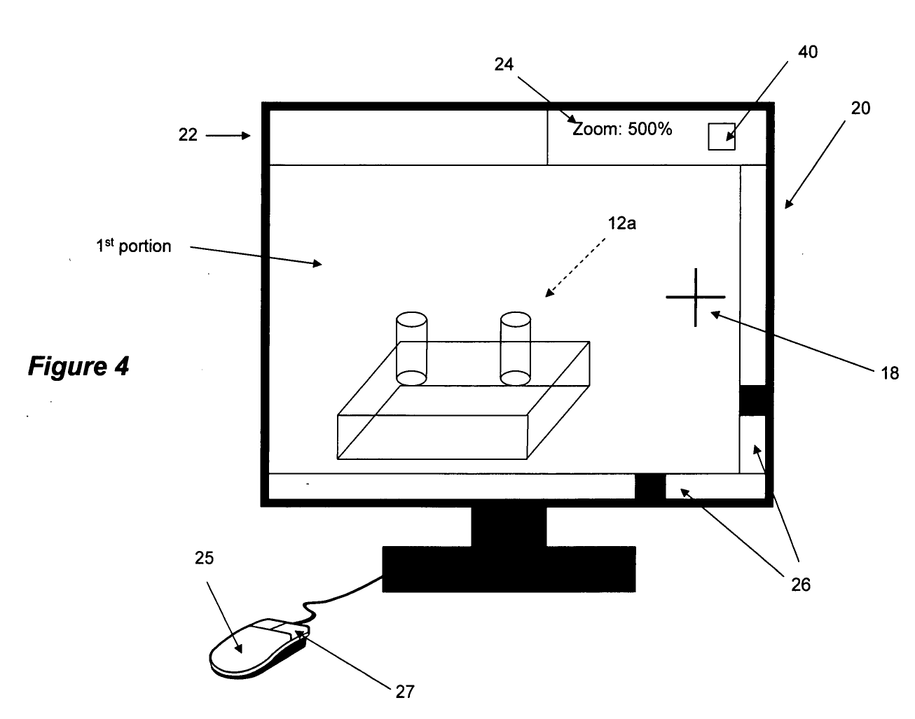

Screen shots of the GUI further illustrating the method of FIG. 3 and further implementation details are shown in FIGS. 4-7. In FIG. 4, the user has manipulated his GUI to display the first portion (12a) of the file 10 at a high magnification. As discussed in conjunction with the prior art, there are many ways to so magnify a file, and they are not reiterated here. Desiring to eventually view a third portion (12b) of the file, the user at this point can use the GUI to engage a lower magnification mode to allow a greater (second) portion of the file 10 to be seen (and preferably the entirety of the fie). This also can be done in several different ways. For example, the user can specify a lower magnification in the magnification window 24, or can depress up/down magnification buttons (not shown). Or, engaging the low magnification view can be accomplished through dedicated or user-programmable keys on the mouse 25 or on the keyboard (not shown), or through the use of drop-down menus. Alternatively, the user depresses a button 40 on the GUI (e.g., using mouse 25 and mouse pointer 18) specifically designed to engage the low magnification view. It is further preferred that by depressing button 40 that the magnification level will automatically be adjusted to allow the file to completely fill the display 20 (i.e., a 100% magnification level in this example). Alternatively, button 40 can be user-programmable to set a desired low magnification level that differs from the default value 100%. In a preferred embodiment, the user depresses a pre-defined key (e.g., the “z” key on the keyboard) to engage the low magnification mode, although use of button 40 is primarily illustrated for convenience.

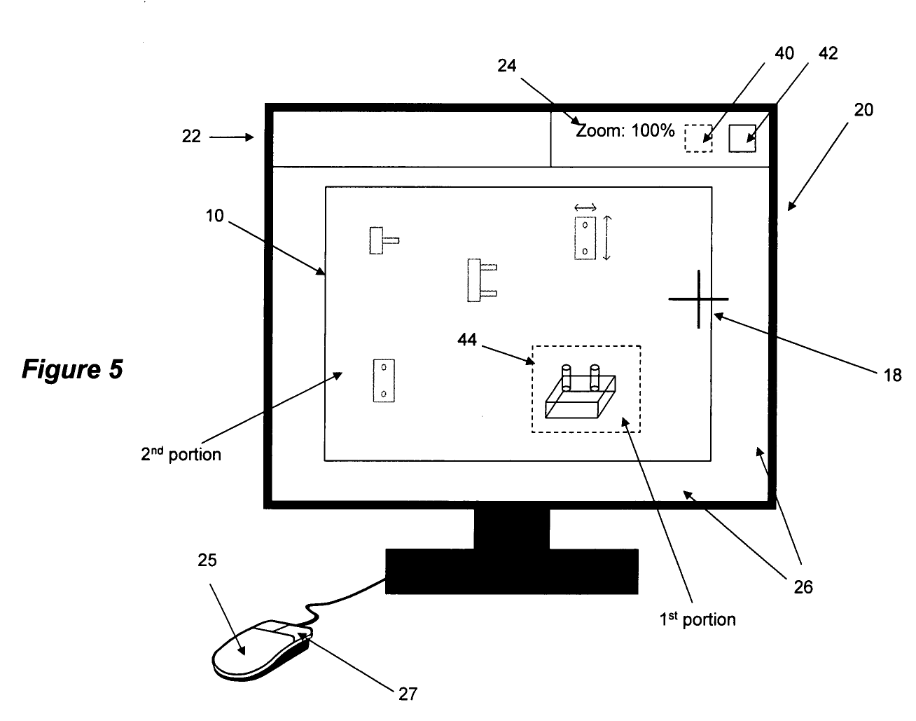

Once button 40 is depressed (or the low magnification view is engaged in some other way), the view on display 20 is updated as shown in FIG. 5 to show the second portion. Once in the low magnification view, low magnification button 40 may disappear (as it may no longer be needed), or may be replaced with a high magnification button 42, which will be explained shortly. In this low magnification view, the (first) portion of the file 10 originally seen in the high magnification view (FIG. 4) is highlighted with respect to the remainder of the file (or other second portions of the file). In a preferred embodiment, such highlighting is accomplished by making the display of the file 10 within the first portion more prominent when compared to the remainder of the second portion. For example, if the file contains black lines as shown, the first portion retains a deep black color while the remaining portions of the file appear relatively gray as shown. If the file contains colored elements, similar brightness reduction of the remaining portions can be accomplished (e.g., from red in the first portion to pink elsewhere). Still other highlighting schemes are possible. For example, the first portion can be drawn in one color (e.g., blue) with the remaining portions in a different color (e.g., black). Or, non-highlighted portions outside of the first portion can appear in dotted lines. Highlighting can also simply (or additionally) constitute the demarcation of a boundary 44 around the first portion. Regardless of the highlighting scheme used, one skilled in the art will appreciate that such highlighting can be effectuated by an algorithm for appropriately manipulating the pixels in the image of the file.

In a preferred embodiment, the transition from the high magnification view (FIG. 4) to the low magnification view (FIG. 5) is gradual. In other words, when a low magnification view is engaged, the images in the file 10 gradually shrink on the display 20 over some period of time (e.g., approximately one quarter of a second) until the second portion comes into view. Such a gradual transition (or animation) can be accomplished through scaling of the pixels comprising the image of the file as one skilled in the art will understand. This effect is preferred as it is pleasing to the user and continually provides a sense of where the first portion appeared in the file so that the user does not become disjointed. For the reader's reference, a gradual transitioning or animation scheme for on-screen windows is disclosed in Exposé™, a feature utilized for viewing the content of multiple windows in the Apple OSX Panther™ (10.3) operating system, which feature is incorporated herein by reference in its entirety. However, use of gradual transitioning is not strictly necessary, as beneficial aspects of the invention are still had if even when the views are “snapped” from high to low magnification.

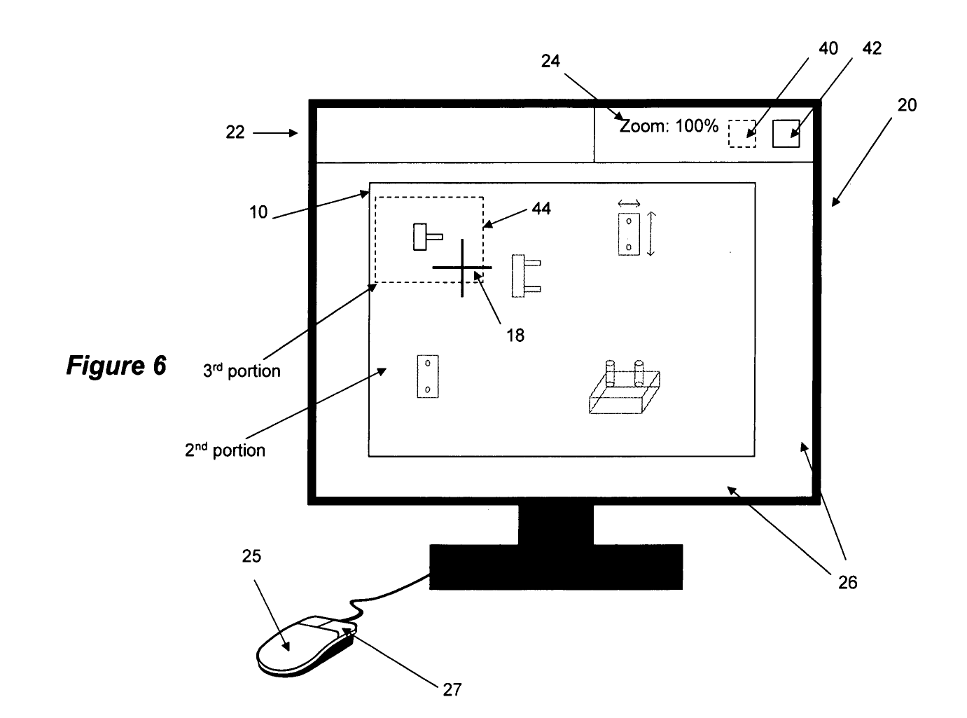

Once the highlighted area is shown, and as illustrated in FIG. 6, the user can move this highlighted area to the next (third) portion of the file that the user wishes to view at high magnification. The highlighted area can be moved many different ways, but is preferably moved by selecting and moving it with the mouse pointer 18, and most preferably by depressing and holding down a mouse button 27 and moving the mouse 25 accordingly to slide the highlighted area around the file. Once selected and moving about the file 10, the highlighted area will preferably update such that all portions of the file appearing within the boundary 44 will be highlighted in any of the fashions discussed above. In any event, with the benefit of the low magnification view of FIGS. 5 and 6, areas of interest in the file can be seen by the user with greater clarity.

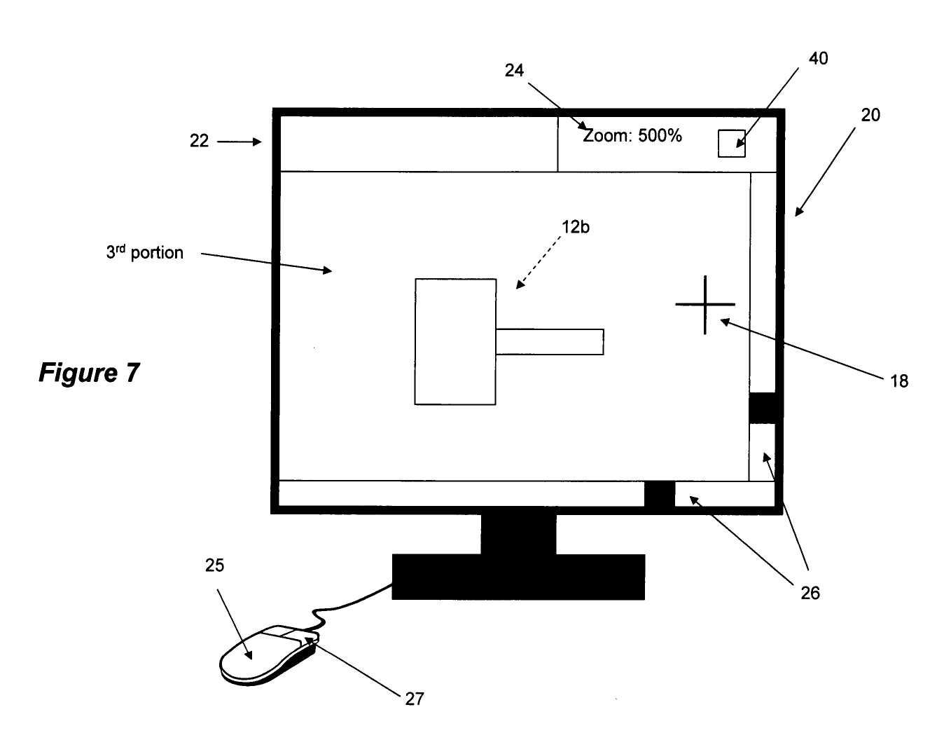

Thereafter, the now selected (highlighted) third portion of the file is brought into high magnification view, as shown in FIG. 7, which again can be accomplished in a number of different ways. In a preferred embodiment, and assuming that the user has selected and is moving the highlighted area by depressing and holding a mouse button 27, the user simply moves the highlighted area to the third portion and releases the depressed button 27. This automatically increases the magnification of the file 10 to bring the third portion into a high magnification view on the display 20 (FIG. 7). Alternatively, the user can move the highlighted area to the third portion, and then manually engage some other option on the user interface to bring the third portion into a high magnification view as defined by the highlighted area. For example, a button 42 on the GUI (FIGS. 5 and 6) can be used to bring the highlighted area into high magnification view, and can be made to function similarly to the low magnification button 40 discussed earlier. Other means to manually transition to the high magnification view can also be used (double clicking the highlighted area, depressing the “enter” key on the keyboard, etc.).

As before, it is preferred that the transition from low (FIG. 6) to high (FIG. 7) magnification occur gradually so that the user sees the portions of the file within the third portion gradually increase in size to fill his display, but again, this is not strictly necessary, and instead the display can “snap” to the high magnification view of the third portion.

The use of the disclosed file navigation system provides benefits over the prior art discussed earlier. By using a low magnification view, the user viewing a particular file should not be prone to getting “lost” within the file. Moreover, use of the GUI at the low magnification view is greatly simplified: previous high magnification views are highlighted, and selection of a new high magnification portion is made without the need for centering or button pushing. Moreover, suitable magnification levels do not have to be specifically input during navigation, but can occur automatically or in conjunction with pre-set levels, reducing required user input to navigate.

Once the functional aspects of the disclosed file navigation scheme are known as disclosed herein, the programming such functionality is a routine matter, and is accomplishable using many different programming languages and within the context of many different operating systems. Accordingly, such coding specifics are not disclosed herein. Of course, ultimately the invention disclosed herein would be coded into compute code and stored on a computer-readable media, such as a compact disk, a tape, stored in a volatile or non-volatile memory, etc.

Useful modifications can be made to the disclosed file navigation scheme. For example, although believed particularly useful in the context of large single-page graphical files, the disclosed technique has utility as to larger paginated files as well, such as word processing files, spreadsheet files, presentation files, etc. Such paginated files when viewed at low magnification can be displayed as a series of tiles or thumbnails representing individual pages, with the highlighted area being moveable over the tiled pages to highlight and view some particular user-specified portion of each page or pages (e.g., the top of given page, some portion of the page, the middle of a page, the right and left halves of two consecutive and tiled pages, etc.).

The magnification levels used in the low and high magnification views can be pre-set either by the application being used to view the file, the operating system, or the user. For example, if the user initially selects a particular high magnification level (e.g., 500%), that magnification will be used as the default value for all subsequent high magnification view, subject to be later changed by the user. The default low magnification level preferably shows the entirety of the file (e.g., 100%), but can similarly be changed by the user. The program and/or user interface can also preset the magnification levels. For example, knowing the size of the user's screen from the operating system, the program and/or operating system can use as a default high magnification level that level which will display the file in accordance with its actual size (i.e., such that 1 square inch of screen space equals one square inch of graphical work space in the file 10). Or, the user may preset the high/low magnification levels of magnification buttons 40 and 42, perhaps in conjunction with a menu associated with those buttons.

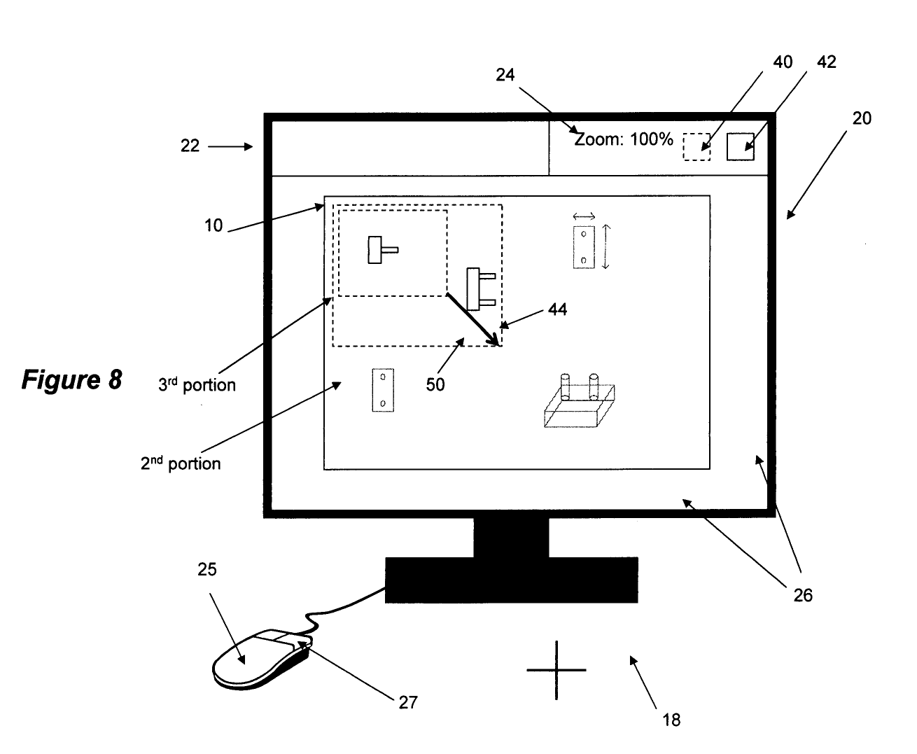

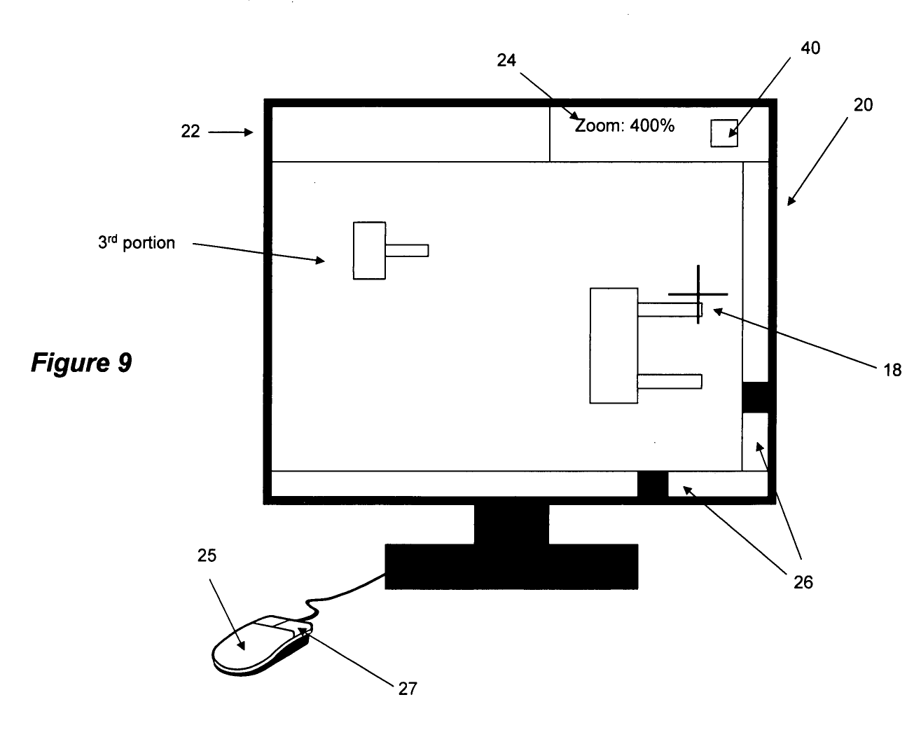

Still other useful modifications are possible. For example, when in the low magnification mode (FIGS. 5 and 6), the highlighted area may be moveable and resizable to adjust the magnification level of the new third portion to be viewed. For example, and as shown in FIG. 8, after the highlighted area defined by boundary 44 is moved to a desired location, that area may be stretched or shrunk (see arrow 50) to cover a portion of the file 10 that is different in size than the original first portion that had been viewed previously at high magnification. Stretching or shrinking of the highlighted area can be accomplished in different ways. For example, while the left mouse button 27 may be used to move the highlighted area to the general location of the third portion, the right mouse button may be used to select and/or stretch or shrink the border, again perhaps by clicking and holding the right mouse button. (Obviously, in this embodiment, automatic higher magnification of the third portion will not be automatic upon moving the highlighted area to the third portion to allow for such border adjustment). Thereafter, when the border is set, the high magnification view of the third portion will be seen (FIG. 9), although because that portion's size is different from the first portion, the level of magnification will be different from the first portion's (e.g., only 400% in the example shown) and may be automatically computed given the relative sizes between the two. Viewing the high magnification view of the third portion in this embodiment can be automatic (e.g., by releasing the right mouse button) or manual (e.g., by having the user depress button 42 on the GUI).

The foregoing description of preferred and other embodiments are not intended to limit or restrict the scope or applicability of the inventive concepts contained herein. It is intended that the inventive concepts contained herein include all modifications and alterations to the full extent that they come within the scope of the following claims or equivalents thereof.

1. A method using a display coupled to a computer for navigating the contents of a file accessible by the computer, comprising:
displaying a first portion of the contents on a region of the display at a first magnification;
selecting a first option to display a second portion of the contents of the file on the display within the region at a second magnification, wherein the second magnification is lower that the first magnification;
defining an area within the displayed second portion by highlighting the first portion;
moving the area to a new location on the displayed second portion to encompass a third portion; and
displaying the third portion on the display within the region at a third magnification, wherein the third magnification is higher than the second magnification.

2. The method of claim 1, wherein the contents of the file constitutes a single graphical file.

3. The method of claim 1, wherein the contents of the file are non-paginated.

4. The method of claim 1, wherein the third portion is displayed automatically after the area is moved.

5. The method of claim 1, wherein the third portion is displayed after the area is moved and after selecting a second option on the display.

6. The method of claim 1, wherein selecting the first option causes a gradual transition between the displayed first portion and the displayed second portion.

7. The method of claim 1, wherein displaying the third portion causes a gradual transition between the displayed second portion and the displayed third portion.

8. The method of claim 1, wherein highlighting the first portion within the displayed second portion comprises prominently displaying the first portion relative to other areas of the displayed second portion.

9. The method of claim 1, wherein highlighting the first portion within the displayed second portion comprises displaying the first portion with a darker grey scale than other areas of the displayed second portion.

10. The method of claim 1, wherein highlighting the first portion within the displayed second portion comprises displaying the first portion with a different color than other areas of the displayed second portion.

11. The method of claim 1, wherein highlighting the first portion within the displayed second portion comprises displaying a border around the first portion.

12. The method of claim 1, wherein the second portion comprises the entirety of the contents of the file.

13. The method of claim 1, wherein the first and third portions are of equal size.

14. The method of claim 1, wherein the first and third magnifications are the same.

15. The method of claim 1, wherein moving the area comprises manipulation of a mouse coupled to the computer.

16. The method of claim 1, wherein moving the area comprises selecting an option on the display.

17. The method of claim 1, wherein before displaying the third portion the highlighted area is changed in size, and wherein the third magnification is different from the first magnification.

18. The method of claim 1, wherein selecting a first option comprises depressing a key or button.

19. A computer-readable medium containing a program for performing a method using a display coupled to a computer for allowing a user to navigate the contents of a file accessible by the computer, the method comprising:
displaying a first portion of the contents on a region of the display at a first magnification;
allowing a user to select a first option to display a second portion of the contents of the file on the display within the region at a second magnification, wherein the second magnification is lower that the first magnification;
defining an area within the displayed second portion by highlighting the first portion;
allowing a user to move the area to a new location on the displayed second portion to encompass a third portion; and
displaying the third portion on the display within the region at a third magnification, wherein the third magnification is higher than the second magnification.

20. The computer-readable media of claim 19, wherein the contents of the file constitutes a single graphical file.

21. The computer-readable media of claim 19, wherein the third portion is displayed automatically after the area is moved.

22. The computer-readable media of claim 19, wherein the third portion is displayed after the area is moved and after selecting a second option on the display.

23. The computer-readable media of claim 19, wherein selecting the first option causes a gradual transition between the displayed first portion and the displayed second portion.

24. The computer-readable media of claim 19, wherein displaying the third portion causes a gradual transition between the displayed second portion and the displayed third portion.

25. The computer-readable media of claim 19, wherein highlighting the first portion within the displayed second portion comprises prominently displaying the first portion relative to other areas of the displayed second portion.

26. The computer-readable media of claim 19, wherein the second portion comprises the entirety of the contents of the file.

27. The computer-readable media of claim 19, wherein the first and third magnifications are the same.

28. The computer-readable media of claim 19, wherein moving the area comprises manipulation of a mouse coupled to the computer.

29. The computer-readable media of claim 19, wherein before displaying the third portion the highlighted area is changed in size, and wherein the third magnification is different from the first magnification.

30. The computer-readable media of claim 19, wherein selecting a first option comprises depressing a key or button.

31. A computer system, comprising:
a computer having access to a file;
a display for displaying portion of the contents of a file within a region of the display;
a program accessible by the computer for displaying the contents of the file within the region of the display, the program allowing the user to:
display a first portion of the contents on a region of the display at a first magnification;
select a first option to display a second portion of the contents of the file on the display within the region at a second magnification, wherein the second magnification is lower that the first magnification, thereby defining an area within the displayed second portion by highlighting the first portion;
move the area to a new location on the displayed second portion to encompass a third portion; and
display the third portion on the display within the region at a third magnification, wherein the third magnification is higher than the second magnification.

32. The computer system of claim 31, wherein the third portion is displayed automatically after the area is moved.

33. The computer system of claim 31, wherein selecting the first option causes a gradual transition between the displayed first portion and the displayed second portion, and/or wherein displaying the third portion causes a gradual transition between the displayed second portion and the displayed third portion.

34. The computer system of claim 31, wherein the second portion comprises the entirety of the contents of the file.

35. The computer system of claim 31, wherein the first and third magnifications are the same.

36. The computer system of claim 31, wherein before displaying the third portion the highlighted area is changed in size, and wherein the third magnification is different from the first magnification.

37. A computer program accessible by a computer for displaying the contents of the file within the region of a display, the program allowing a user to:
display a first portion of the contents on a region of the display at a first magnification;
select a first option to display a second portion of the contents of the file on the display within the region at a second magnification, wherein the second magnification is lower that the first magnification, thereby defining an area within the displayed second portion by highlighting the first portion;
move the area to a new location on the displayed second portion to encompass a third portion; and
display the third portion on the display within the region at a third magnification, wherein the third magnification is higher than the second magnification.

38. The computer program of claim 37, wherein the third portion is displayed automatically after the area is moved.

39. The computer program of claim 37, wherein selecting the first option causes a gradual transition between the displayed first portion and the displayed second portion, and/or wherein displaying the third portion causes a gradual transition between the displayed second portion and the displayed third portion.

40. The computer program of claim 37, wherein the second portion comprises the entirety of the contents of the file.

41. The computer program of claim 37, wherein the first and third magnifications are the same.

42. The computer program of claim 37, wherein before displaying the third portion the highlighted area is changed in size, and wherein the third magnification is different from the first magnification.

43. A computer using a display coupled to a computer for navigating the contents of a file within the computer, wherein a first portion of the contents are displayed on a region of the display at a first magnification, comprising:
means for selecting a first option to display a second portion of the contents of the file on the display within the region at a second magnification, wherein the second magnification is lower that the first magnification;
means for defining an area within the displayed second portion by highlighting the first portion;
means for moving the area to a new location on the displayed second portion to encompass a third portion; and
means for displaying the third portion on the display within the region at a third magnification, wherein the third magnification is higher than the second magnification.
